(19) United States
(12) Patent Application Publication
(10) Pub. No.: US 2007/0174876 A1
(43) Pub. Date: Jul. 26, 2007

(54) Method and system for providing broadband access, HDTV, and broadband-enabled services

(75) Inventors: Frank S. Maggio, St. Petersburg, FL (US); Timothy Blair Gasquez, Tampa, FL (US)

Correspondence Address: KING & SPALDING LLP, 1180 PEACHTREE STREET, ATLANTA, GA, 30309-3521, US

(73) Assignee: Media IP Holdings LLC

(21) Appl. No.: 11/603,795

(22) Filed: Nov. 22, 2006

Related U.S. Application Data
(60) Provisional application No. 60/778,640, filed on Mar. 1, 2006.
(60) Provisional application No. 60/761,673, filed on Jan. 24, 2006.

(51) Int. Cl. H04N 7/173; H04N 7/18

(52) U.S. Cl. 725/78; 725/81; 725/80; 725/118

(57) ABSTRACT

A communication gateway can provide a residence or a premises with access to multiple communication services, including reception of TV signals and bidirectional data communication. The gateway can reformat incoming TV signals to provide compatibility with an onsite TV. The incoming TV signals may be digital or may provide a higher level of pixel definition or screen resolution than the onsite TV is configured to handle. The gateway can convert the incoming TV signals into an analog form or can reduce the pixel definition for reception by the onsite TV. To support bidirectional data communications, the gateway can comprise a wireless interface to a LAN and an interface to broader network, such as a WAN. The gateway can process data signals flowing between the LAN and the WAN to provide format compatibility and can track media exposure. In one exemplary embodiment, the WAN can transmit television signals as packets.

### CROSS REFERENCE TO RELATED APPLICATIONS

This application claims priority to U.S. Provisional Patent Application Ser. No. 60/778,640, filed Mar. 1, 2006, having attorney docket number 58368.105028-P and entitled “Method and System for Providing Broadband Access, HDTV, and Broadband-Enabled Services,” the entire contents of which are hereby incorporated herein by reference.

This application also claims priority to U.S. Provisional Patent Application Ser. No. 60/761,673, filed Jan. 24, 2006, having attorney docket number 58368.105022-P, and entitled “Method and System for Characterizing Advertising Audiences,” the entire contents of which are hereby incorporated herein by reference.

### FIELD OF THE INVENTION

The present invention relates to providing integrated access to wireless communication services and more specifically to a gateway or an access point that offers a premises or a residence access to television and data services.

### BACKGROUND

Television (TV) is evolving. Under a mandate of the United States federal government, TV broadcasters are switching from a half-century-old analog transmission system to a digital system that promises to use public airwaves more efficiently and to improve broadcast quality. The target date for completing the transition from analog to digital is Feb. 17, 2009. In the United States, digital TV is based on Advanced Television Systems Committee (ATSC) standards. High definition TV (HDTV) is a subset of digital TV and generally encompasses the higher-resolution formats that the ATSC standards reference.

Although HDTV and the associated digital broadcasting system may offer enhanced TV services, compatibility issues exist between analog TVs and digital TV networks. Many consumers own analog TVs that receive analog TV signals broadcast over an analog cable network or via an antenna. As such, those “legacy” TVs generally lack a capability to handle HDTV signals. Thus, many TVs are ill equipped for the digital broadcast upgrade that is scheduled for Feb. 17, 2009.

The term “legacy,” as used herein with reference to a TV or some other media device or receiver, generally means that the device has compatibility issues with signals that a user of the device would like for the device to receive. For example, an analog TV or a standard definition TV (SDTV) that a person has owned for many years may not be capable of receiving digital or HDTV signals that are forthcoming. A legacy TV may operate at a different level of screen resolution, provide a different density of pixels, or have lower definition than the newer HDTVs.

The planned transition to HDTV also presents issues to the entities that distribute information via TV. For example, municipalities and governments may seek to communicate with the public and their constituents using the HDTV medium. However, if a portion of the public lacks sufficient communication capabilities to properly use HDTV signals, then some individuals may not be able to be receive important announcements or other government information. Moreover, conventional technologies may not provide sufficient infrastructure to cost effectively reach a population.

Another problem with most conventional technologies concerns supporting the disparate communication devices that the occupants of a single residence may own and operate. For example, a single residence might have two or more HDTVs, SDTVs, digital radios, analog radios, handheld computing devices, personal computers (PCs), printers, networking appliances, and peripherals, as well as various other types of computing and communication devices. Using conventional technologies, the residence may further need a wide assortment of gear to properly interface each of these devices with the Internet, a TV distribution network, a satellite communication system, a wide area network (WAN), etc.

With a single residence having a wide variety of media appliances and media forms, using conventional approaches to evaluating media exposure for occupants of the residence is typically problematic. During a relatively small amount of time, such as an hour, an occupant of the residence may receive exposure to digital radio, cell phone advertising, HDTV advertisements and content, SDTV advertisements and content, Internet-based content, etc. Tracking each such exposure, while desirable, is not generally feasible with conventional audience monitoring technologies.

To address the representative deficiencies in the art discussed above, a need exists for a method and system that can upgrade analog TVs to receive digital signals. Another need exists for interfacing legacy analog TVs to digital networks, such as networks that conform to ATSC standards. Yet another need exists for using HDTV infrastructure to benefit governments, elected officials, and citizens. One more need exists for a network that can deliver data and video services to users who operate a variety of communications gear. Still another need exists for a technology that can deliver multiple communication services through a single gateway. And, another need exists for a capability to track a wide variety of media exposures for multiple users and multiple media appliances at a residence. A capability fulfilling one or more of these needs would promote access to communication services.

### SUMMARY OF THE DISCLOSURE

The present invention supports providing a home or a residence with access to two or more communication services. The services can comprise TV service and data communication service, for example.

In one aspect of the present invention, a system handles incoming television signals and bidirectional data signals. The system can be characterized as a communication gateway or an access point and can be housed in an enclosure. The gateway can reformat incoming television signals to provide compatibility with a TV or a video monitor that is nearby or that is collocated. The incoming TV signals may be digital or may provide a higher level of pixel definition or screen resolution than the TV is configured to handle. The gateway can convert digital TV signals into an analog form and/or can reduce the pixel definition of the incoming signals for reception by the TV. Thus, the gateway can receive HDTV signals, transmitting in open air for example, and can output signals that an SDTV can properly receive. To support bidirectional data communications, the gateway can comprise a wireless interface to a local area network (LAN) and an interface to a wide area network (WAN). The gateway can process data signals flowing between the LAN and the WAN to provide format compatibility. That is, the gateway can receive wireless data signals output by a nearby computing device and can prepare those signals for transmission on a broader communication network that extends to other sites, regions, cities, or locations. Likewise, the gateway can receive data signals from the WAN and can format those signals for transmission over the LAN.

The discussion of accessing communication services presented in this summary is for illustrative purposes only. Various aspects of the present invention may be more clearly understood and appreciated from a review of the following detailed description of the disclosed embodiments and by reference to the drawings and the claims that follow. Moreover, other aspects, systems, methods, features, advantages, and objects of the present invention will become apparent to one with skill in the art upon examination of the following drawings and detailed description. It is intended that all such aspects, systems, methods, features, advantages, and objects are to be included within this description, are to be within the scope of the present invention, and are to be protected by the accompanying claims.

### BRIEF DESCRIPTION OF THE DRAWINGS

FIG. 1A is a diagram of an exemplary wireless mesh network for delivering communication access to a plurality of premises according to an embodiment of the present invention.

FIG. 1B is a diagram of an exemplary wireless network, comprising interconnected base stations, for delivering communication access to a plurality of premises according to an embodiment of the present invention.

FIG. 2 is a high-level block diagram of an exemplary communication system that couples a premises to two networks according to an embodiment of the present invention.

FIG. 3 is a high-level block diagram of an exemplary communication system that couples a premises to a wireless mesh network according to an embodiment of the present invention.

FIG. 4 is a functional block diagram of an exemplary system for providing integrated access to a plurality of communication services according to an embodiment of the present invention.

FIG. 5 is a diagram that illustrates an exemplary operational function of a system for providing integrated access to a plurality of communication services according to an embodiment of the present invention.

FIGS. 6A and 6B, collectively FIG. 6, respectively are front and back views of an exemplary system for providing integrated access to a plurality of communication services according to an embodiment of the present invention.

FIG. 7 is a flowchart of an exemplary process for providing integrated access to a plurality of communication services according to an embodiment of the present invention.

Many aspects of the present invention can be better understood with reference to the above drawings. The elements and features shown in the drawings are not to scale, emphasis instead being placed upon clearly illustrating the principles of exemplary embodiments of the present invention. Moreover, certain dimension may be exaggerated to help visually convey such principles. In the drawings, reference numerals designate like or corresponding, but not necessarily identical, elements throughout the several views.

### DESCRIPTION OF EXEMPLARY EMBODIMENTS

The present invention supports providing integrated access to broadband, broadband infrastructure, communication services, TV, and/or media content. The present invention also can support tracking exposure to various forms of media and/or exposure to media content presented on assorted media appliances for each user at a residence or a premises.

As discussed below in further detail, an exemplary embodiment of the present invention can comprise one or more of the following elements:

1) a system that provides a compact interface or an integrated gateway to multiple communication services or to multiple communication networks, each having distinct protocols or signal characteristics;

2) a system that provides new, superior, or cost-effective services to subscribers, with an a la carte ability to acquire some or all of the hardware based upon the consumer's needs and desires;

3) a system that can flexibly evolve to facilitate adding new system capabilities as technologies emerge to support those capabilities;

4) a method of conducting business related to providing, selling, or marketing broadband services and infrastructure;

5) applications that increase interaction between governments and citizens;

6) an open platform or gateway through which media, communication, and/or computing devices at a residence can gain connectivity to access communication services, messages, and content; and

7) a capability for tracking media consumption, viewership, and/or content shown for multiple media devices, communication appliances, and/or computing systems of a residence.

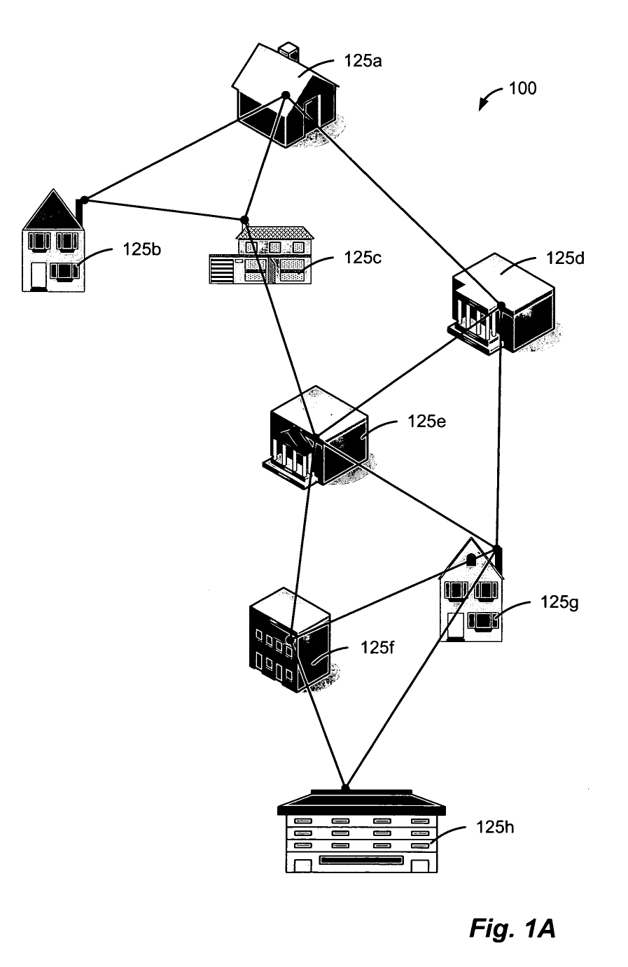

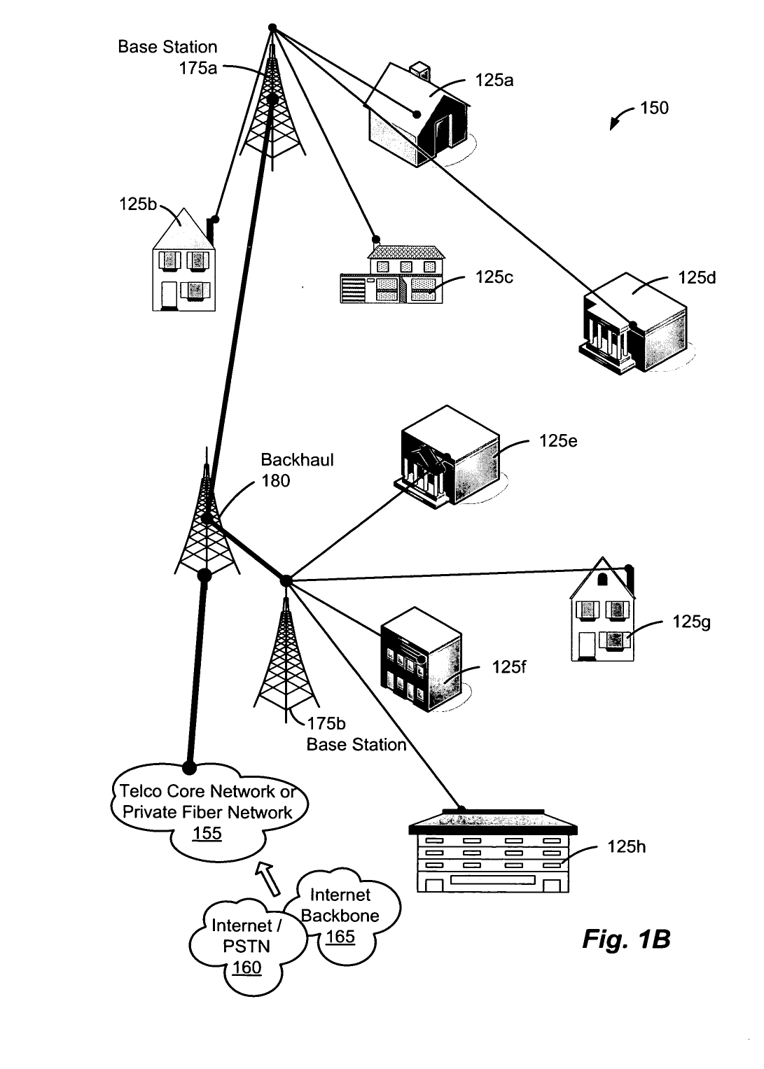

One exemplary embodiment of the present invention comprises a system that provides legacy analog TVs with connectivity to an HDTV network that is configured in a wireless mesh architecture. The HDTV network can comprise the system 100 or the system 150 that FIGS. 1A and 1B respectively illustrate, as discussed in further detail below.

One exemplary embodiment of the present invention comprises a hand-held remote control that links a legacy analog TV to a wireless HDTV network and that offers its user a host of interactive services and capabilities.

One exemplary embodiment of the present invention comprises a wi-fi system that provides improved bandwidth and/or signal reception. The wireless network system, based on a mesh network architecture, can provide high-bandwidth access and can provide that access in areas that are outside the line-of-sight limitations of conventional wireless transmission paths.

One exemplary embodiment of the present invention relates to a method for marketing or selling broadband infrastructure and/or services delivered via a wi-fi or wireless mesh network. The method of marketing or selling wi-fi mesh network infrastructure can comprise a profit- or benefit-sharing arrangement that incentivizes collaboration between a city government and a network owner or a communication service provider.

One exemplary embodiment of the present invention supports a method and system for improved interaction between an electorate and an elected official. Via such a method and system, an elected official can receive input from voting constituents about pending government decisions, whereby each constituent's input is weighted according to rules that pertain to a level of constituent knowledge of pending decisions.

One exemplary embodiment of the present invention provides a capability to track exposure to assorted media forms, delivered via assorted media appliances, at a site. An integrated communication/media gateway can identify essentially every media exposure that occurs at the site as a result of a communication signal transmitting through the gateway. Thus, the gateway can be viewed as a fused ratings platform. Moreover, the gateway can comprise an open-platform, signal-agnostic, cross-media communication device that not only bridges protocol compatibility issues, but also tracks exposure to a wide variety of media content forms. Such forms may include digital, non-digital, and/or analog content comprising sound, text, and/or images, to name a few examples.

Prior to describing the Figures in detail, certain exemplary embodiments of the present invention and certain exemplary applications of those embodiments will be discussed in overview. The below text includes heading that are provided merely for the convenience of the reader and should not be interpreted as limiting the discussion thereunder.

### Method and System for Adapting Analog Televisions to Receive Digital Signals

An exemplary embodiment of the present invention supports providing legacy analog TVs with connectivity to a digital or HDTV network. The digital network can be a wireless network, such as a wireless network configured in a mesh architecture as shown in FIG. 1 and discussed below.

The mesh network can comprise at least one node that connects to at least three other nodes. That is, a node or connection point in a mesh network can comprise an intersection of three or more data links or data transmission paths. Mesh networks can provide adaptability, flexibility, and/or fault tolerance.

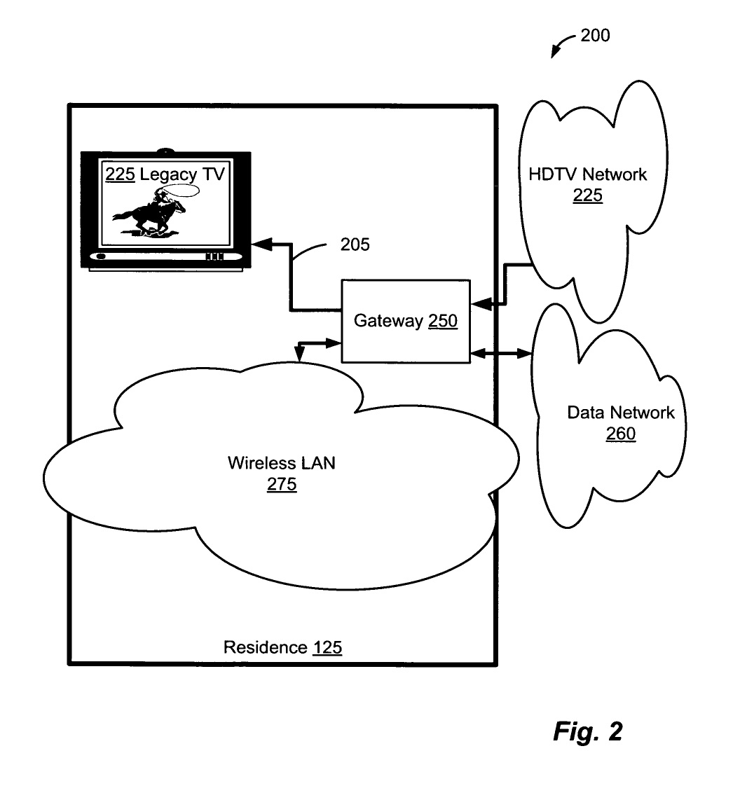

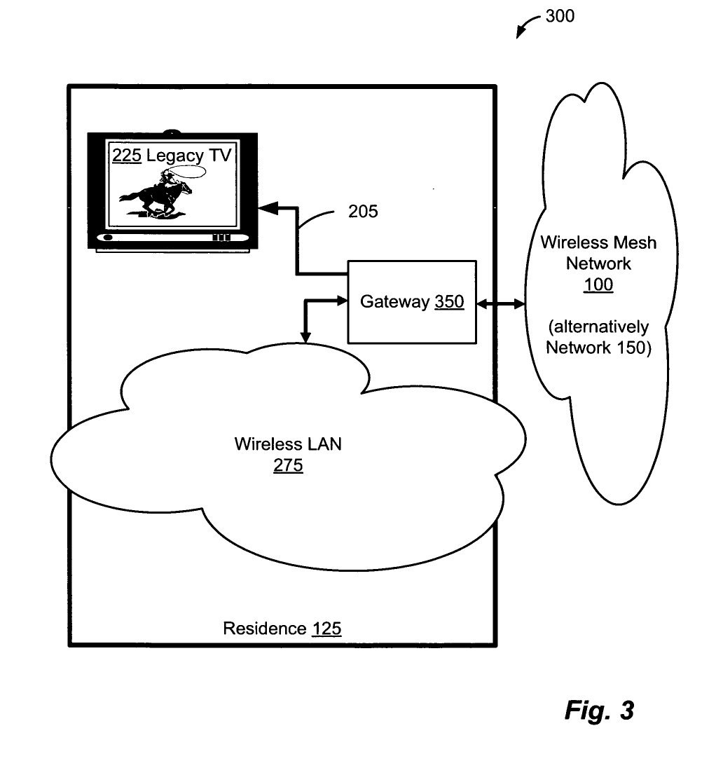

A system or gateway that connects an analog TV to a digital network can be a module or unit that is physically connected to the TV and that is housed in a separate enclosure from the TV. The gateway 250 of FIG. 2 or the gateway 350 of FIG. 3, both discussed below, can comprise such a system. The gateway can alternatively be a component of a handheld device, such as a remote control. Thus, a remote control that a person uses to select a TV channel can provide its associated TV with connectivity to wireless signals that carry digital information.

Whether embodied in a handheld unit or an enclosure that is stationary in normal operation, one exemplary embodiment of the gateway will be referred to herein as a MaxBox or MuniMax MaxBox system or device. That is, the term “MaxBox” or “MuniMax MaxBox” can refer to a communication gateway or to a system, device, or apparatus that functions as an adapter between an analog TV and a wireless digital network.

Beyond its signal conversion role, the MuniMax MaxBox system can be viewed as an a la carte hardware solution that provides or supports various viewer services, such as interactive or reactive TV.

In the form of a handheld device, a reactive remote control can be enhanced with MuniMax/WIMAX chips. The WIMAX chips provide the reactive remote with connectivity to the wireless digital network.

WIMAX, as will be appreciated by those skilled in the art, is a standards-based wireless technology that supports high-throughput broadband connections, often over long distances. Typical applications of WIMAX technology include “last mile” broadband access, cellular backhaul and hotspots, and providing businesses or enterprises with high-speed access.

In one exemplary embodiment, the remote control provides direct network connectivity. Thus, in various exemplary embodiments, a MaxBox remote control can function without a home base-station, a wi-fi base station, a repeater device, or some other intermediary or buffer between the remote control and the digital network. In other words, the remote control can send and receive signals to the TV and can send and receive signals over a wireless mesh network that carries digital TV signals. Moreover, the reactive or interactive MaxBox remote control can comprise voice over Internet protocol (VoIP) functionality.

U.S. patent application Ser. No. 11/479,709, entitled “Method and System for Automatically Substituting Media Content” and filed on Jun. 30, 2006, describes various handheld devices, media systems, communication devices, remote controls, and media appliances that can be integrated with the MaxBox system. That is, remote controls or other systems disclosed, discussed, or taught in U.S. patent application Ser. No. 11/479,709 can be outfitted to provide an analog or legacy TV with connectivity to a digital or HDTV network. Furthermore, a MaxBox system can provide any of the capabilities or functions described in U.S. patent application Ser. No. 11/479,709, the entire contents of which are hereby incorporated herein by reference.

The MaxBox system can receive an HDTV signal and convert that HDTV signal into an analog signal suitable for reception by a legacy or analog TV. Thus, the MaxBox system can perform a method that comprises the following steps:

(1) receiving wireless digital signals that carry TV programming or video content;

(2) decoding the received signals to identify the carried programming;

(3) generating analog TV signals;

(4) modulating the analog signals with the identified programming (or encoding the identified programming onto the generated analog signals); and

(5) outputting the modulated analog signals for reception by the legacy or analog TV.

In receipt of the analog signals from the MaxBox system, the legacy or analog TV shows the programming that the digital network carries, or a representative derivative of that programming.

Via the MaxBox system, TV systems that lack inherent capabilities for receiving HDTV signals can remain operational and useful after digital convergence occurs in 2009 and TV affiliates cease broadcasting analog signals. In one exemplary scenario, households with over-the-air (OTA) TV systems can receive a government contribution or subsidy, such as $50, for upgrading those systems. That subsidy may be applied towards obtaining a MaxBox system, for example.

The MaxBox system can also receive content specifically tailored or created for transmission over a digital network to which the MaxBox system is connected. Further, that content can be delivered via an IP-addressable “tuner.” Content intended for transmission over the digital or HDTV network or intended for reception by a MaxBox system can be termed MuniMax content. MuniMax content can be exclusively received by MaxBox systems or alternatively can be targeted for reception by both MaxBox receivers and other media receivers.

One or more MuniMax channels can carry government programming, for examples as a government channel. MuniMax channels that are transmitted on an HDTV network via IP may also be received on computers or other Internet-enabled devices. In other words, a local government can provide content over the HDTV network via IP. That same content can be transmitted over a network capable of handling IP traffic, such as the Internet or an intranet. In this manner, a government can provide its constituents with information through an HDTV outlet and/or online via a computer, a handheld, an IP-enabled cellular device, or some other platform.

In one exemplary embodiment, the MaxBox system comprises or provides digital video recorder (DVR) functionality, allowing the downloading of a la carte content for viewership as and when wanted, or on an on-demand basis.

In one exemplary embodiment, the MaxBox system comprises or couples to one or more base stations. Such base stations can boost over-air signal strength. In other words, a base station can receive wireless HDTV signals, apply gain to those received signals, and output the resulting amplified HDTV signals. In this sense, the base station can provide a repeater functionality.

Buildings or residences equipped with or located near one or more such base stations can receive HDTV signals without needing an unsightly antennae that is visible from the street, for example.

In one exemplary embodiment, the MaxBox system functions as a provider-agnostic Internet protocol television (IPTV) box. That is, the MaxBox system can provide a user with the ability to receive IPTV content from any of a variety of sources. More specifically, the MaxBox system can allow connectivity to a wide variety of equipment, addresses, and/or people located on the Internet or another IP-based network.

In one exemplary embodiment, the MaxBox system tracks viewership or determines viewing statistics. In this embodiment, the MaxBox system determines the channel setting, and thus the content, that its user has selected for viewing. In one embodiment, the MaxBox can identify the content based on the channel setting of each media device that receives signals from the MaxBox. One or more such media devices, or associated remote controls, can transmit the channel settings to the MaxBox via a radio frequency link. In one embodiment, the MaxBox functions as a tuner and records tuner commands from the media devices or the remote controls. Alternatively, the MaxBox can determine viewed channels via monitoring the signals (for example signal load, current, or voltage at specific channel frequencies) that flow through the MaxBox. The MaxBox system transmits the content identity over the HDTV network, or some other network to a receiving station. The receiving station can be a central site or facility that aggregates viewing statistics across the HDTV network, typically from a large number of viewers.

In other words, each MaxBox system in a network of systems can identify the state of its associated TV or remote control and can transmit state-change information from each system to a central location. In this manner, each family, residence, or party that uses a MaxBox system to receive HDTV signals can have an influence on TV ratings. Thus, each connected family can participate in generating or counting towards “Nielsen”-style ratings.

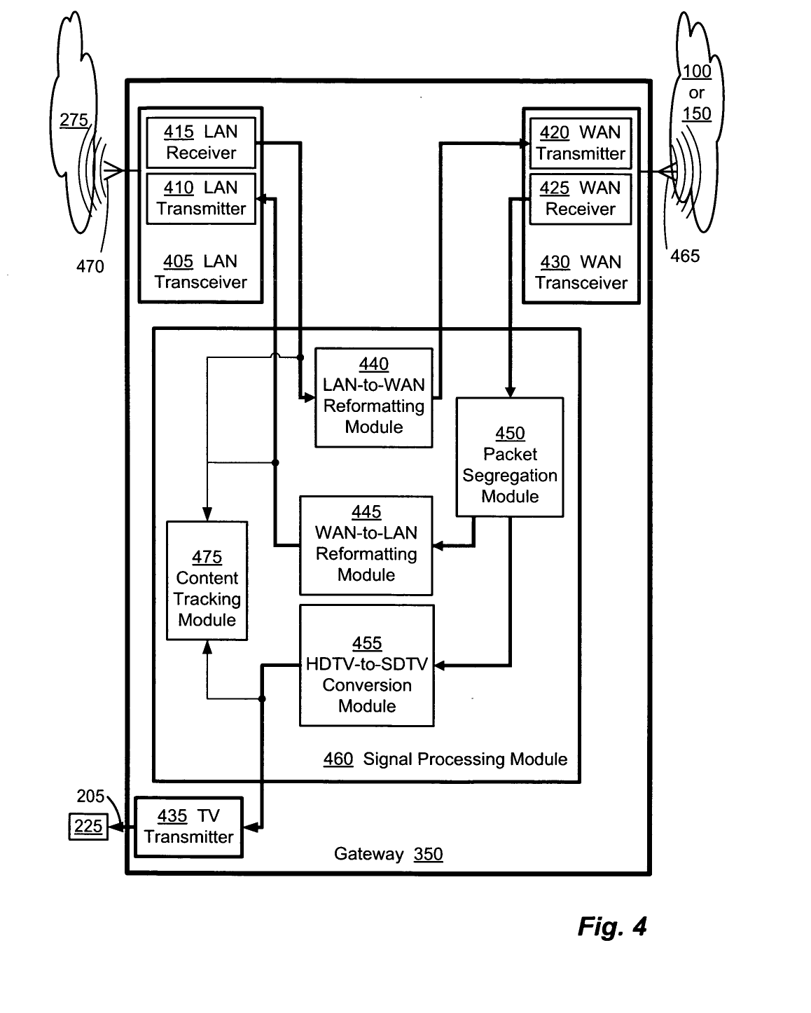

In this manner, viewing data can be obtained in a privacy compliant manner. Demographic information can be associated with the statistics of one or more monitored viewers. Moreover, the systems and methods of erinMedia Inc. of Bradenton, Fla. can obtain and/or process data from each MaxBox system. As an incentive to participate in a ratings program, a household can receive a discount on an HDTV service or a rebate on the purchase price of MaxBox hardware, for example. As discussed in further detail below with reference to FIG. 4, participation can be verified using inverse demographic matrix (IDM) technology, identity management, or intelligent device management. In one exemplary embodiment, users can permanently or temporarily opt out of participation in a viewship analysis or ratings program. For example, a user may elect to temporarily disable the MaxBox system's capability to track viewership.

In one exemplary embodiment, the MaxBox system comprises or functions as a wi-fi base station. As such, the system allows wi-fi and/or WIMAX devices of a residence or building to use the MaxBox system as a router to the Internet. That is, disparate computing and/or communication appliances can link to the Internet through the MaxBox system.

In one exemplary embodiment of the present invention, the base station functionality of the MaxBox system is integrated with a wi-fi reactive remote control. In other words, a TV remote control or some other handheld can function as a wi-fi base station. Moreover, a remote control with that capability can provide emergency information to its user, for example providing on-screen severe weather warnings, “Amber” alerts, etc. The alerts can appear on a display of the remote control or alternatively on a TV associated with the remote control.

As discussed in further detail below, the user can also watch live government proceedings on TV and make voting entries on the remote control. Those entries can influence or define a government decision, such as a vote placed by an elected official as a representative of his constituents. For example, an elected official can receive input in real-time or near-real-time from his constituents and can, based on that input, cast a vote on behalf of those constituents.

An exemplary embodiment of the MaxBox system comprises an open-platform Internet-protocol-based (1P-based) residential gateway set top box (STB). The system is compatible with digital, HDTV, wireless mesh networks, and/or OTA digital TV. Moreover, the MaxBox system functions with the MuniMax municipal wireless infrastructure that is discussed in further detail below.

An exemplary embodiment of the MaxBox system can access fixed, nomad, and mobile WIMAX standards signals complying with the IEEE 802.16 standard. Further, the system can serve as a wireless access point and network router/address translator for current and future Wi-Fi standards devices complying with the IEEE 802.11b/g/n standard. Due to an open IP platform, the MaxBox system can receive and decode IPTV via the Internet and/or TV content provided via MuniMax service and accessed through the MaxBox “tuner.” Moreover, the system provides access to web-based audio, visual, and/or audio/video services and to the Internet.

The MaxBox system, via its WIMAX high-throughput two-way wireless broadband connection, can collect and deliver statistics regarding its user's viewing habits or patterns. Those statistics typically remain privacy compliant.

An onboard storage capability, such as a hard drive or some other machine-readable medium, can store media content. In one exemplary embodiment, the MaxBox system can record and store standard-definition television (SDTV) content as well as HDTV content. For example, the hard drive may hold 200 hours of SDTV content and a corresponding amount of HDTV content.

The MaxBox system can be controlled by a wireless reactive or interactive remote control that complies with the standard known as IEEE 802.11g.

As discussed in further detail below, numerous copies or instances of the MaxBox system can connect to a single broadband or HDTV network. That network can serve a city, municipality, township, community, or some other entity or group of people.

### Providing Broadband Infrastructure

A broadband infrastructure can comprise a plurality of MaxBox systems connected to a digital network, an IP network, an HDTV network, a wireless network, a wireless mesh network, or some hybrid network thereof. Various homes, offices, hotels, and other facilities in a city, municipality, or township can each have or use a MaxBox system. Each of those MaxBox systems can offer the occupants of its associated facility a range of communication services and capabilities. FIGS. 1A and 1B, discussed in further detail below, provide illustrations of such an infrastructure.

An enterprise, referred to herein as a MuniMax operation, uses that broadband infrastructure to provide cost-effective wireless broadband services and solutions to an organization and its constituents or residents. The organization can comprise a city, a city government, a political organization, a municipality, a township, a state, a metropolitan area, a federal government, etc. The constituents can be citizens of the city, for example. A MuniMax operation can be a private enterprise, a public enterprise, or an enterprise based on a public-private partnership.

As discussed in further detail below and elsewhere herein, if the MuniMax operation is deployed across a state's major metropolitan areas, the state government can obtain significant benefit. If multiple states deploy MuniMax technology, the federal government can benefit.

In one exemplary embodiment, the technology infrastructure of a MuniMax network comprises a multiple input multiple output (MIMO) wi-fi mesh solution or network. A city can commission or hire the MuniMax operation to install and maintain that MIMO wi-fi mesh solution.

MIMO technology, as will be appreciated by those skilled in the art, refers to a technology for transmitting wireless data at high bit rates, for example achieving 100 Mbps throughput rate using the 801.11 standard. MIMO technology splits a feed data stream into multiple data streams, each having a lower rate. Using multiple paths, and typically multiple antennas, MIMO technology can increase communication bandwidth.

The MIMO wi-fi mesh solution can comprise a version of wi-fi that offers speed enhancements, for example providing a four-fold increase over many typical wi-fi technologies. The network further comprises a WIMAX backhaul tied to a wired Internet service. In one exemplary embodiment, the network is further linked to a provider of TV and/or Internet content.

As an alternative to creating a technology infrastructure based on a MIMO wi-fi mesh solution, a city may elect to wait until 2007 for the planned rollout of WIMAX hardware, discussed above. Although this approach may delay the citizens' access to MuniMax-enabled services, it may provide certain advantages. Such advantages may include cost savings, maintenance savings, quicker deployment once construction commences, and higher profit.

Using WIMAX hardware as the basis for the technology infrastructure allows the MuniMax operation to bypass wi-fi hot-spot deployment, with fewer WIMAX base stations that can reach 3 to 5 miles each, and with limited need for wi-fi base stations in canyons and remote areas near a WIMAX base station.

Similar to the MIMO wi-fi mesh solution, the WIMAX hardware system can use a WIMAX backhaul that ties to a wired Internet service and that may further link to a TV provider and/or an Internet content provider.

### Cooperation Between a City and a Provider of Broadband Infrastructure

A government entity, such as a city government, can cooperate with the infrastructure provider so that both parties receive benefit from the relationship. Moreover, economic or other incentives can foster such cooperation. The incentives can comprise a profit- or benefit-sharing arrangement between or among two or more of the infrastructure provider, a business entity that provides the broadband services, the government, and citizens affiliated with the government.

In one exemplary embodiment of the present invention, municipalities may elect to become “anchor tenants” of the MuniMax services, at reduced prices, in exchange for providing the MuniMax operation with access to local rights of ways and easements. The municipality can use MuniMax services to handle most or all government Internet needs, as well as communication support for fire, police, and government offices.

In one exemplary embodiment of the present invention, a municipality partners or “ventures” with the MuniMax operation. As a partner and/or equity holder in the MuniMax operation, the municipality can receive profit distributions. The profit distributions can be applied towards or credited against the municipality's communication and Internet connectivity costs. Income that the municipality receives above those communication expenses can be applied towards other government operational costs, such as rent, utilities, payroll, etc.

In one exemplary embodiment of the present invention, the municipality may protect a private MuniMax operation from third-party wireless providers that may compete with the MuniMax operation in the municipality. The protection can prevent third-parties from operating on frequencies that might “step on” and negatively impact MuniMax service to the government and consumers. In other words, a for-profit business may receive certain exclusive rights or certain benefits in connection with providing communication infrastructure and/or services to the municipality.

### Enhancing Interaction Between a Government and Citizens of the Government

Based on the MuniMax network's connectivity to the populous and to the government, citizens can interact with the government to obtain information and to influence decisions of elected officials. Moreover, the capability to answer questions and to submit information via remote controls and other convenient handheld devices provides citizens with new avenues for government participation. Thus, a MuniMax network can be viewed as enabling or promoting democracy and can provide exciting civic connections and robust reactive content and applications.

Thus, in one exemplary embodiment of the present invention, a method and system supports improved interaction between an electorate and an elected official. Via that method and system, an elected official can receive input from voting constituents about pending government decisions. Each constituent's input can be weighted according to rules that pertain to a level of constituent knowledge of pending decisions.

In one exemplary embodiment of the present invention, software and/or services, termed a MuniMax CiviConnect system, provides constituents with access to their elected officials and provides officials with access to their constituents.

In an exemplary embodiment, the MuniMax CiviConnect system comprises or links to a server and database. Via the server and database, an elected or appointed official can readily poll citizens regarding their opinions on important matters.

The official can also add “informed screening” content that requires a citizen to read background materials and to verify comprehension of a matter before being cleared to cast a vote. Alternatively, votes submitted without verification can be weighed less than votes submitted with the verification. For example, a vote from an informed citizen could be equivalent to two, three, five, ten, twenty, or one hundred, or to some other number in a range thereof, of uninformed or unverified votes. The weighting can be implemented in a computer executed process based on software, for example.

In one exemplary embodiment, the MuniMax system helps a government official collect well-written opinions on both sides of a matter or issue under consideration or debate. Those opinions can be posted on a public website of the CiviConnect system, for example. Thus, citizens can view, over the MuniMax network, both sides of the matter before casting an electronic vote.

A citizen posting an option can identify himself or alternatively can elect to remain anonymous. Further, elected officials can weigh in with their own opinions, with the website showing the officials' opinions or positions.

The website can categorize matters under consideration according to topic. Exemplary topical categories can include financial, property rights, human rights, etc. Over time, by weighing each matter and then recording the vote of the citizen, the citizen and official both can learn about the dispositions or leanings of one another. That is, the website can track each citizen's online votes and/or opinions for review by the official, the voter, and/or other citizens. In this manner, users can track trends of individual citizens, groups of citizens, and/or elected officials.

A citizen user can remain anonymous while using a consistent and/or persistent system ID number. In this manner, citizen voting patterns and opinions can be tracked while maintaining secrecy of the citizen's true name and/or public identity.

In one exemplary embodiment of the present invention, the MuniMax system tracks how often the citizen is on the winning or losing side of a decision. An official can elect to use the database to poll specific, selected, or individual voters based on their historical voting patterns. Such polls can provide opinions or assistance in formulating the official's opinion.

Officials can develop a “jury” method of voting. That is, an official can specify how heavily he wishes to rely on certain core constituents, or alternatively on his total constituents, to sway his individual votes. That is, an official can identify a group of citizens whose opinions he wishes to track, to consider, or to heed. The opinions or votes of various members of the group can be weighted according to criteria or weighting factors that the official has specified in the system.

The system also allows citizens to see how officials vote, and how often they attend hearings and place votes. This information can be available to the press, as well as all citizens, depending on how open and democratic the forum is. In one exemplary embodiment, the MuniMax system supports chat functions. Thus, constituents can have access to a full-time forum for expressing ideas, improvement proposals, etc.

The CiviConnect software can promote, elevate, or increase the efficiency of the democratic process, with a focus on adding an education element. The system's software can allow officials or citizens to take polls, which can be privately or publicly accessed.

With the “weighting” feature, the system can determine patterns that indicate when a matter has traction, is gaining popularity, or is changing the minds of voters. For example, the MuniMax system might reveal that voters who are fiscally conservative voters are leaning in favor of an amendment or ordinance that one would otherwise think they would vote against.

As discussed above, citizens can use an interactive or reactive remote control for interacting with the CiviConnect system. Moreover, citizens can access real-time or prerecorded broadcasts relevant to an issue under consideration, for example in the form of programming available on the C-Span network or an educational network,.

Other applications that the MuniMax system can support include rapid dissemination of important or time-sensitive information. For example, a remote control, TV, or computer coupled to the MuniMax network can display public announcements such as Amber alerts, tornado and severe weather warnings, and hurricane updates.

Configuring a device to display public warnings or other information can be a simple procedure. For example, a personal computing device can be enabled by loading software on the device or on a remote control that authorizes the MuniMax system to launch warning information.

Warning updates can be an opt-in capability, whereby users select what types of warnings they desire to receive. In times of civil unrest, or foreign invasion, the wireless system connects citizens to one another and to their government and provides important warnings. Such capabilities would further be useful in weather emergencies and similar circumstances.

Beyond benefiting city governments, elected officials, and local citizens, the MuniMax system can benefit states that have adopted MuniMax technology. That is, a state benefits when the state's cities and communities embrace MuniMax technology. Similarly, the federal government benefits when states and cities use MuniMax technology. Thus, a country can enhance its democratic processes and provide connectivity between and among various officials and citizens. Moreover, the benefit can reach international levels or be transcontinental.

### DISCUSSION OF FIGURES

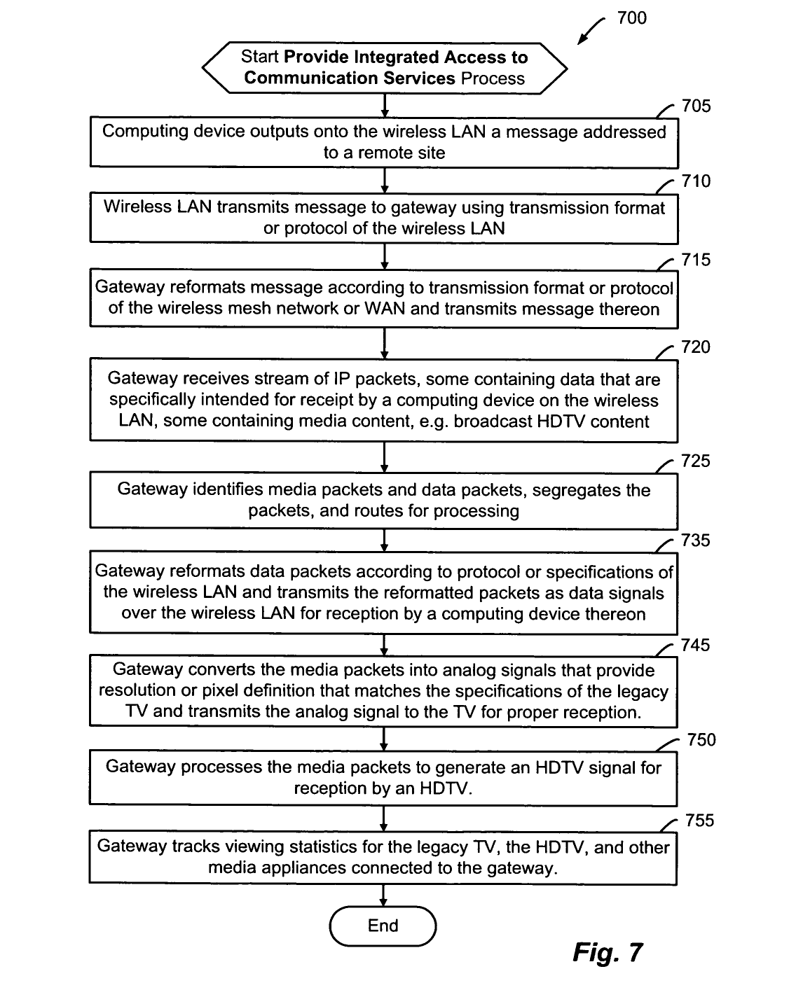

FIGS. 1-7, which describe exemplary embodiments of the present invention will now be discussed. FIGS. 1A and 1B show diagrams of representative network architectures that provide premises or residences with connectivity. FIGS. 2 and 3 show residence-to-WAN connections. FIGS. 4, 5, and 6 present functional and physical aspects of a communication gateway. FIG. 7 illustrates a process for providing integrated communication connectivity.

As discussed above, the figures illustrate representative methods and system for carrying out or conducting the applications and processes discussed above. That is, the above described technologies can be embodied in, or can be otherwise associated with, one or more of the systems and methods of FIGS. 1-7.

Turning now to FIG. 1A, this figure illustrates a wireless mesh network 100 for delivering communication access to a plurality of premises 125a-h in accordance with an exemplary embodiment of the present invention.

In an exemplary embodiment, the wireless mesh network 100 offers a range of communication capabilities and services to each premises 125. Such communication capabilities and services can comprise two or more of Internet connectivity, access to government services, informal or formal voting, telephone service, TV service, emergency alerts, radio, movies, video, on-demand video, HDTV, SDTV, home shopping, remote computing, work-at-home, telecommuting, IPTV, IP telephony, and VoIP, to name but a few possibilities. The premises 125 typically comprise residences, homes, offices, businesses, government buildings, hotels, convention centers, sites that distribute media (such as TV, radio, etc.), schools, churches, factories, etc.

In an exemplary embodiment, the wireless mesh network 100 is a wireless cooperative communication infrastructure comprising numerous transceivers, one at each premises 125. Each premises 125 can send, receive, and repeat, and thus route, information to other premises 125. Thus, each premises 125 comprises a node on the network 100. Any specific premises 125a has a defined range of direct communication, limiting that premises 125a to directly exchanging messages with nearby premises 125b, 125c, 125d. However, one premises 125a can communicate with another distant premises 125h by transmitting information to a neighboring premises 125c that forwards the information to its neighbors, and so forth. For example, the premises 125a may send a message to the premises 125h via the premises 125c, 125e, and 125g, each forwarding the message in turn.

In other words, a packet of data, information, images, or video can hop between each premises 125 until it arrives at its destination or destinations. Each premises 125 has a gateway 250 (not explicitly illustrated in FIG. 1A, but shown in FIG. 2) or some other communication system that can forward routing information of the packet to the gateway 250 of its neighboring premises 125. Thus, each premises 125 has hardware that can determine whether a packet is to be kept onsite or is alternatively to be forwarded.

As discussed in further detail below, those packets can be used to distribute TV or other media content as well as for computer-to-computer communication or for data communication. The wireless mesh network 100 can comprise a packet-switched network or a distributed computing network.

A routing algorithm can manage or optimize the handoff of packets to achieve a speed, efficiency, latency, or bandwidth objective. Numerous algorithms and routing technologies are available that the wireless mesh network 100 may use. Such algorithms may include AODV (ad-hoc on demand distance vector), PWRP (predictive wireless routing protocol), DSR (dynamic source routing), OLSR (optimized link state routing), TORA (temporally ordered routing algorithm), or HSLS (hazy sighted link state), to name a few possibilities.

The wireless mesh network 100 can span a community, a city, a region, a metropolitan area, a state, a country, or a continent, for example. Accordingly, the wireless mesh network 100 can directly or indirectly encompass either a large or a relatively small geographic area. Accordingly, 100s, 1,000s, 100,000s or 1,000,000s of premises 125 can be connected to one another. The wireless mesh network 100 can further include links that connect meshes to one another. For example, a mesh in one city can be connected with a mesh in another city via an uninterrupted communication link, such as a satellite link or a fiber optic cable.

The wireless mesh network 100 is inherently fault tolerant. If one premises 125 experiences a hardware failure, the wireless mesh network 100 can heal itself, via routing around the fault. The wireless mesh network 100 tends to provide inherent load balancing, as an increase in bandwidth naturally follows from increasing the number of premises 125. Each added premises 125 provides another transmission path. Accordingly, the infrastructure grows incrementally in a way that avoids the capital intensive expansion of many other communication systems. Consequently, a municipality or other government entity experiencing rapid growth can adopt or sponsor mesh network technology with relatively low cost.

In one exemplary embodiment, the wireless mesh network 100 can comprise a massive array cellular system (MACS). In one exemplary embodiment, the wireless mesh network 100 can comprise multiple fixed base stations (not explicitly illustrated in FIG. 1A) that provide express paths to various locations of the network 100. For example, a first base station can receive messages from multiple premises 125 in one area of a city and then forward those messages to a second base station in another area of the city. The second base station can then send the received messages to the intended destinations. In this manner, the base station infrastructure provides “cut through” bandwidth that helps the wireless mesh network 100 operate efficiently. FIG. 1B, discussed below, provides an exemplary network, that comprises base stations operating according to this principle.

In an exemplary embodiment, the wireless mesh network 100 can comprise MIMO technology, as discussed above. MIMO technology can be phased-in to the network 100 as that technology becomes increasingly available and evolves in sophistication. In one exemplary embodiment, the wireless mesh network 100 can be viewed as a wi-fi mesh solution.

In various embodiments, the wireless mesh network 100 can comprise a MuniMax network, a Maxbox network, and/or a CiviConnect network. The wireless mesh network 100 can couple to the Internet, a video distribution network, a cable network, a media distribution network, a packet-switched network, a distributed computing network, or various other networks known in the art. The wireless mesh network 100 may use a WiMax backhaul, tied to a wired Internet service provider (ISP). Moreover, a backhaul infrastructure that is similar to the backhaul system of FIG. 1B, discussed below, can feed the wireless mesh network 100. Accordingly, the premises 125 can receive data services, Internet access, HDTV, SDTV, digital TV, radio, IPTV, VoIP, voice communications, e-mail, and/or other information, data, content, or images that may be transmitted wirelessly.

Turning now to FIG. 1B, this figure illustrates a wireless network 150, comprising interconnected base stations 175b, for delivering communication access to a plurality of premises 125a-h in accordance with an exemplary embodiment of the present invention. The wireless network 150 provides communication, computing, and connectivity services to the premises 125 in an alternative network architecture to the wireless mesh network 100 discussed above with reference to FIG. 1A.

The public switched telephone network (PSTN) 160 and/or the Internet backbone 165 feed the telecommunications core network 155. The PSTN 160 can also feed a private fiber network 155. The telecommunications core network 155, in turn, feeds a backhaul system 180, typically comprising wireless communication towers. Accordingly, the network 150 can comprise one or more circuit-switched networks, packet-switched networks, or distributed computing networks.

The backhaul system 180 feeds a system of base stations 175a, 175b. Each base station 175 in the system 150 provides the final access link to the nearby premises 125 via wireless communications. The base station 175a serves the premises 125a, 125b, 125c, and 125d, while the base station 175b serves the premises 125e, 125f, 125g, 125h.

In exemplary embodiments, the wireless network 150 can be characterized as a WiMAX network or a HIPERMAN network. Moreover, the wireless network 150 can conform to one or more networking standards such as IEEE 802.16, IEEE 802.16e, IEEE Std 802.16e-2005, or Mobile WiMax.

Turning now to FIG. 2, this figure illustrates a high-level block diagram of a communication system 200 that couples a premises 125 to two networks 225, 260 in accordance with an exemplary embodiment of the present invention.

The illustrated system 250, denoted “gateway 250,” is one exemplary embodiment of a gateway and will be referred to as such. Moreover, the gateway 250 is one exemplary embodiment of the MaxBox system or the MuniMax MaxBox system discussed above.

The gateway 250 comprises a module that receives HDTV or digital signals from the HDTV network 225 and, as discussed above, outputs analog signals that the legacy TV 225 can properly receive. In various exemplary embodiments, the HDTV network 225 can comprise an OTA network, a satellite distribution network, or even a wired or cable network.

Another module of the gateway 250 reformats the signals passing between the wireless LAN 275 and the data network 260 for protocol and format compatibility. The wireless LAN 275 provides communication and computing devices at the premises 125 with device-to-device communication. The wireless LAN 275 can operate in accordance with an industrial standard, such as Bluetooth, IEEE 802.15.1, or some other communication standard or protocol. With the capabilities of the gateway 250, the devices on the wireless LAN 275 can link to remote sites on or attached to the data network 260.

The HDTV network 225 and the data network 260 can be two physically distinct networks. Further, those networks 225, 260 can be segregated from one another. In one exemplary embodiment, one of the HDTV network 225 and the data network 260 is connected wirelessly to the gateway 250, while the other is connected via a physical wire, such as a coaxial cable. That is, one of the HDTV network 225 and the data network 260 may communicate with the gateway 250 via a wire or a wire line while the other communicates using air as a signal propagation medium.

In one exemplary embodiment, the HDTV network 225 and the data network 260 can each comprise a virtual network on a single physical network. Thus, either the wireless mesh network 100 or the wireless network 200 discussed above could comprise the HDTV network 225 and the data network 260 in virtual forms. In other words, a single physical network could comprise the HDTV network 225 and the data network 260.

Turning now to FIG. 3, this figure illustrates a high-level block diagram of a communication system 300 that couples a premises 125 to a wireless mesh network 100 in accordance with an exemplary embodiment of the present invention. In an exemplary embodiment, the wireless mesh network 100 or the wireless network 150 can comprise the system 300 that FIG. 2 illustrates.

The illustrated system 350, denoted “gateway 350,” is one exemplary embodiment of a gateway and will be referred to as such. Moreover, the gateway 350 is one exemplary embodiment of the MaxBox system or the MuniMax MaxBox system discussed above. Further, the gateway 350 can comprise an access point, an intelligent connection, a network node, an inter-network node, or a signal reformatting station.

From its location at or on the premises 125, the gateway 350 provides the premises 125 with access to communication-oriented services, media, content, data, broadband, TV, and/or information (as discussed above). The gateway 350, which is described in further detail below, comprises a link 205 to a legacy TV 225 and further provides the premises 125 with Internet and other data-oriented services.

The premises 125 comprises a wireless LAN 275 that allows various computing devices (not explicitly illustrated on FIG. 3) at the premises 125 to communicate with one another and to connect with the wireless mesh network 100 via the gateway 250. Thus, the gateway 250 functions as an integrated access point for the wireless LAN 275 and the legacy TV 225. As such, the gateway 250 provides, reformats, or adapts communication signals for inter-network compatibility. Consequently, a user of an Internet-enabled TV, a laptop, a handheld, or a stationary PC can access an array of remote network resources via the gateway 350.

Turning now to FIG. 4, this figure illustrates a functional block diagram of a system 350 for providing integrated access to a plurality of communication services in accordance with an exemplary embodiment of the present invention. More specifically, FIG. 4 presents an exemplary embodiment of the gateway 350 that FIG. 3 illustrates, as discussed above.

The gateway 350 comprises at least one antenna 465 that sends data to and receives data from the wireless mesh network 100 or the wireless network 150. The antenna 465 may be mounted on a roof and connected to the housing of the gateway 350 via a wire or some other signal conduit. Alternatively, the antenna 465 may be mounted on or in the housing of the gateway 350.

In one exemplary embodiment, the gateway 350 comprises two antennas at the transceiver 430, one for sending signals to the wireless mesh network 100, and one for receiving signals from the network 100. In such case, a single antenna 465 handles both media/video packets containing information that the legacy TV 225 will receive and data packets associated with the wireless LAN 275.

On the WAN side and associated with the antenna 465, the gateway 350 comprises a WAN transceiver 430 that includes a WAN transmitter 420 for delivering signals to the wireless mesh network 100 and a WAN receiver 425 for receiving signals from the wireless mesh network 100. Media packets and data packets typically both propagate through the WAN receiver 425.

The term “transceiver” as used herein, generally refers to a system that transmits and receives signals that carry information. A transceiver 430, as illustrated, can comprise a transmitter 420 and a receiver 425 that are not necessarily integrated together in a unitary structure or enclosure.

On the premises side, the gateway 350 comprises an antenna 470 and an associated LAN transceiver 405 that includes a LAN transmitter 410 and a LAN receiver 415. The antenna 470 is typically mounted on or in the housing of the gateway 350 to provide short range communication with the wireless LAN 275.

Also on the premises side, the gateway 350 comprises a transmitter 435 for sending appropriately formatted TV signals to the legacy TV 225, typically via coaxial cable.

A signal processing module 460, generally comprising circuitry and software, processes incoming and outgoing signals to provide format and operational compatibility. Moreover, the signal processing module 460 typically comprises a microcontroller, power supplies, memory, analog electronics, etc.

The microcontroller may comprise a microprocessor as well as other digital circuitry, for example flash memory, random access memory (RAM), and erasable programmable read only memory (EPROM), to name a few examples. Flash memory can facilitate adding or updating software functionality, which can be downloaded from a remote site.

The microcontroller can be coupled to or can comprise various types of memory such as any one or combination of volatile memory elements (e.g., forms of RAM such as DRAM, SRAM, SDRAM, etc.) and nonvolatile memory elements (e.g., ROM, hard drive, tape, CDROM, etc.). Moreover, the microcontroller's memory may incorporate electronic, magnetic, optical, and/or other types of storage media. The memory can have a distributed architecture, where various components are physically remote from one another, but can be accessed by the microcontroller's microprocessor or other computer of the microcontroller.

A “computer-readable medium” can be any means that can store, communicate, propagate, or transport a program for use by or in connection with an instruction execution system, apparatus, or device. For example, the computer readable medium can be, but is not limited to, an electronic, magnetic, optical, electromagnetic, infrared, or semiconductor system, apparatus, device, or propagation medium. More specific examples (a nonexhaustive list) of the computer-readable medium include the following: an electrical connection (electronic) having one or more wires, a portable computer diskette (magnetic), a RAM (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The microcontroller can also include logic implemented in hardware with any or a combination of the following technologies: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

In the illustrated embodiment, the signal processing module 460 comprises a LAN-to-WAN reformatting module 400 that receives digital data from the wireless LAN 275 and formats the data for transmission over the wireless mesh network 100, which can be considered an exemplary WAN.

The packet segregation module 450 receives incoming packets from the wireless mesh network 100 and segregates or routes those packets according to the information they contain. Data packets are routed to the WAN-to-LAN reformatting module 445 while video or TV packets are routed to the HDTV-to-SDTV conversion module 455.

The WAN-to-LAN reformatting module 445 reformats data packets for compatibility with the wireless LAN 275. The LAN transceiver 405 outputs those packets onto the wireless LAN 275.

The HDTV-to-SDTV conversion module 455 extracts the video and audio information from each media/TV/video packet and uses that information to create a signal that the legacy TV 225 can properly receive and use. As discussed above, the HDTV-to-SDTV conversion module 445 typically creates an analog signal appropriately modulated to carry the video and audio information at an appropriate resolution or definition.

The content tracking module 475 monitors signals flowing into and/or out of the gateway 350 to track the exposures that occur at the premises 125. Thus, the content tracking module 475 can identify each time that a user sees, views, or otherwise perceives advertising, entertainment, or informational content associated with a communication that enters or leaves the premises 125 via the gateway.

In one exemplary embodiment, the content tracking module 475 identifies content via monitoring the signal load, signal voltage, signal current, or some other signal parameter across a range of frequencies. The content tracking module 475 then determines the channel settings of the media or computing devices that receive information through the gateway 350 based on the relative values of those signal parameters at each channel-setting frequency.

In one exemplary embodiment, the content tracking module 475 receives channel identification signals from the media and computing devices connected thereto. One or more remote controls that interface with and tune the legacy TV 225, a HDTV, and other media and computing appliances can transmit channel commands to the gateway 350. The gateway 350 can then identify the channel settings based on those commands. In one embodiment, such a remote control can set the gateway 350 to specific channel settings. Thus, the gateway 350 can operate as a flexible tuner that serves multiple media appliances in a residence 125 and can identify content according to those channel settings.

The content tracking module 475 can create an exposure profile for each user at the premises 125. The exposure profile can characterize each user's exposure according to media type, media device, time, or some other parameter(s). Exposures that may be tracked can comprise HDTV content, SDTV content, analog content, digital content, analog radio content, digital radio content, Internet usage, Internet video, cell phone advertisements, gaming interactions, instant messages, blogging statistics or information, video game content, home shopping purchases, transactions, on-demand content, broadcast content, etc. The content tracking module can create a record or a list of such exposures and can transmit the record or list, or an integrated profile thereof, to a remote site via the network 100 or the network 150.

In one exemplary embodiment of the present invention, the content tracking module 475 applies statistical processing to characterize one or more users, groups of users, or audience segments associated with the gateway 350. The characterization can be used as a basis for targeting advertisements to one or more such audience segments. In one exemplary embodiment of the present invention, the content tracking module 475 applies inverse demographic matrix (“IDM”) techniques or technologies for audience characterization and for targeting advertisements to specific audience segments.

The content tracking module 475 can apply and/or can comprise one or more of the methods, systems, and/or teachings disclosed in U.S. patent application Ser. No. 10/282,069, filed Oct. 29, 2002, published Sep. 11, 2003, and entitled “Content Reaction Display,” the disclosure of which is hereby incorporated herein by reference. Moreover, the content tracking module 475 can apply and/or comprise one or more of the methods, systems, and/or teachings of U.S. patent application Ser. No. 10/241,841, filed Sep. 12, 2002, published Aug. 7, 2003, and entitled “Event Invalidation Method,” the disclosure of which is hereby incorporated herein by reference.

Moreover, the content tracking module 475 can apply and/or can comprise one or more of the methods, systems, and/or teachings disclosed in U.S. Provisional Patent Application Ser. No. 60/761,673, filed Jan. 24, 2006, and entitled “Method and System for Characterizing Advertising Audiences,” the entire contents of which are hereby incorporated herein by reference. Following that disclosure, the gateway 350 can generate an integrated profile for each user at the premises 125, describing each user's media exposure in detail. Moreover, the integrated media profile can characterize each media content segment delivered over a wide variety of media appliances at the premises 125.

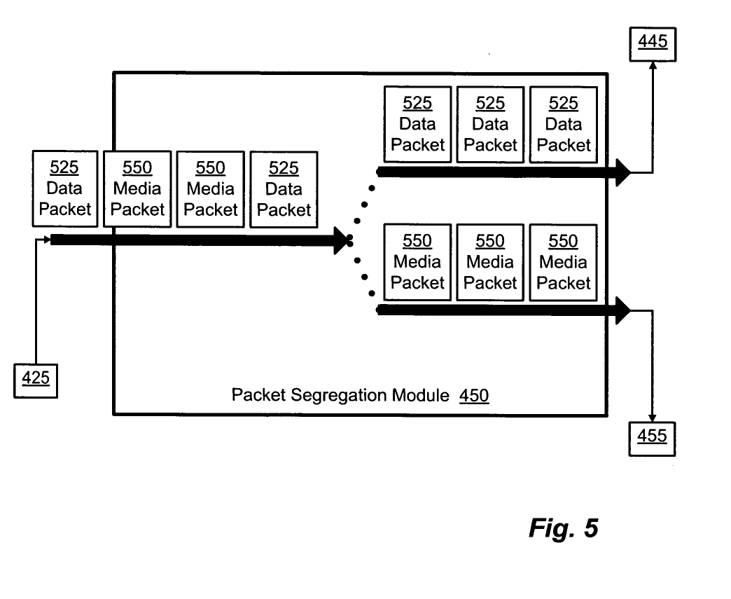

Turning now to FIG. 5, this figure illustrates an operational function of a system 450 for providing integrated access to a plurality of communication services in accordance with an exemplary embodiment of the present invention. More specifically, FIG. 5 shows a representative operation of the packet segregation module 450 that FIG. 4 illustrates, as discussed above.

Incoming signals from the wireless mesh network 100 typically comprise packets 525, 550, some packets 550 containing media content and others containing data content. The media packets 550 could comprise video, voice, audio, images, radio, TV, HDTV, IPTV, advertising, government messages, emergency alerts, CiviConnect information, voting instructions, etc.

As will be appreciated by those skilled in the art, each packet 525, 550 can comprise an IP address, a header, a destination address, routing information, origination information, or other identifying information that the packet segregation module 450 uses to help identify the media packets 550.

The packet segregation module 450 routes the data packets 525 to the WAN-to-LAN reformatting module 445 and the media packets 550 to the HDTV-to-SDTV conversion module 455 for processing as discussed above. Accordingly, the legacy TV 225 and the wireless LAN 275 each receives signals that are tailored for proper interpret and use.

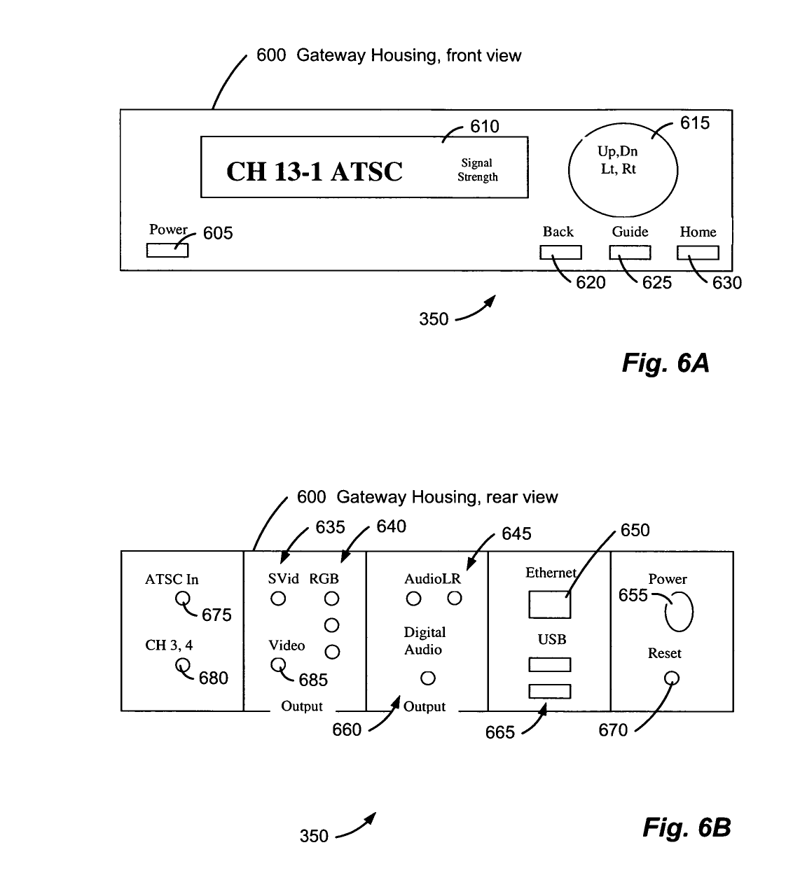

Turning now to FIG. 6, this figure illustrates front and back views of a system 350 for providing integrated access to a plurality of communication services in accordance with an exemplary embodiment of the present invention. More specifically, FIGS. 6A and 6B depict the front and the rear of a portable enclosure or housing 600 of an exemplary embodiment of the gateway 350 shown in FIG. 5 and discussed above.

FIG. 6 shows typical indicator lights, control buttons, input ports, and output ports present on the housing 600 of the gateway 350. In an exemplary embodiment, the gateway 350 can be disposed in a residence at the premises 125, adjacent the legacy TV 225, where it functions as a set top box. The enclosure 600 can be attached to the legacy TV 225 or can be moved from room-to-room by its user, for example.

In one exemplary embodiment, the enclosure 600 (or some similar device) is handheld and may further comprise a functionality to remotely control the legacy TV 225, operating as an interactive remote control, for example. Moreover, such a remote control can provide CRĀV functionality to support CRĀV interaction with commercials, advertisements, or media content.

In an exemplary embodiment, the illustrated gateway 350 of FIG. 6 can be a MaxBox system or a MuniMax MaxBox device that provides an interface to a CiviConnect network, as discussed above. CRĀV features can be integrated with such a MuniMax, MaxBox, or CiviConnect system, with the system constructed in an interactive remote control.

Referring now to FIG. 6a, the front of the gateway housing 600 has a power indicator 605 that shows a user whether the gateway 350 is on or off. A display 610 shows the current channel that the user has selected as well as the strength of the received signal.

The user can turn the knob 615 to change channels or select the “back” button 620 to return to a previously viewed channel. A guide button 625 takes the user to a programming guide or menu, typically shown on the monitor of the legacy TV 225. Meanwhile, selecting the home button 630 causes the legacy TV 225 to show a home page, for example of a Internet site, a municipal government, the CiviConnect operation, or a service provider.

In one exemplary embodiment, the illustrated user interaction items 605, 610, 615, 620, 625, 630 are soft buttons or keys on an interactive remote control, or even on the screen of the legacy TV 225, rather than being physical devices as illustrated.

Referring now to FIG. 6B, the rear of the gateway housing 600 comprises a connector or port 675 for receiving ATSC signals. In one exemplary embodiment, an output line from an antenna disposed at the premises 125, for example on a rooftop, couples to the housing 600 via the port 675. Accordingly, through port 675, the gateway 350 receives OTA digital TV signals that the gateway 350 decodes and translates from the digital domain to the analog domain, as discussed above.

The system outputs the decoded signals to the legacy TV 225 through the Channel 3 or 4 output feed 680, typically at NTSC resolutions of 480×400i60. That is, a coaxial cable 205 plugs into the port 680 and to the legacy TV 225. The cable 205 supplies legacy analog signals on Channel 3 or Channel 4, according to user preference.

The illustrated exemplary gateway embodiment 350 is further equipped with National Television System Committee (NTSC) Composite, S-Video, and Component HD/SD video output signals. Thus, the gateway 350 can supply analog signals to the legacy TV 225, while concurrently providing service to a digital TV or an HDTV.

The size of a video image is typically measured in pixels for digital video or horizontal scan lines for analog video. In a typical embodiment, the gateway's analog signals, provided via the port 680, support compatibility with an SDTV/legacy TV 225 system having 640×480i60 for NTSC resolution, which is a representative rather than limiting specification. Meanwhile, the gateway 350 emits HDTV signals at resolutions of 1920×1080p60, i.e. 1920 pixels per scan line by 1080 scan lines, progressive, at 60 frames per second. The user can connect an HDTV to the SVid port 635, the video port 685, or the red green blue (RGB) ports 640 to supply digital video signals to the HDTV.

The illustrated exemplary embodiment can support ATSC enhanced definition (ED) and high definition (HD) standards for Dolby 5.1-channel audio via the coaxial digital output 660, labeled “Digital Audio.” The left and right analog audio outputs 645, labeled “AudioL-R,” provide standard stereo analog and Dolby Prologic audio.

The exemplary gateway 350 is equipped with IEEE 802.3ab standard 1000BASE-T Gigabit Ethernet connectivity via the port 650, which is labeled “Ethernet.” The Gigabit Ethernet capability supports external LAN connectivity, distribution of media, and third-party remote control of the gateway 350 and various computing, communication, and entertainment appliances connected thereto. Accordingly, the gateway 350 can provide or couple to mode or router capabilities.

The exemplary gateway 350 also comprises USB 2.0 ports 665, shown under the label “USB.” These ports 275 provide connectivity to peripherals such as mice, keyboards, gamepads and joysticks, scanners, digital cameras, printers, external storage, networking components, IR controllers, etc.

As discussed above, in an exemplary embodiment, the gateway 350 can comprise an antenna 470 that provides an interface to the wireless LAN 275. An onboard IEEE 802.11 wireless access point 405, 410, 415, 470 (not illustrated in FIG. 6) is capable of connecting and routing customer premise wi-fi devices to the Internet and/or to MuniMax and/or CiviConnect services. That wireless access point 405, 410, 415, 470, typically internal to the housing 600, provides wi-fi devices in the vicinity of MaxBox system with a host of services. Those services may include wireless access to the Internet, connectivity to proprietary services associated with the MaxBox system, and/or communication with other networks to which the MaxBox system is linked.

A power button 655 provides a user with a capability to remove power from the gateway 350 via physically depressing the button 655. A typical power specification is 120V, 60 Hz AC. A reset button 670, labeled “Reset,” allows a manual reboot of the gateway's operational software and operating system (OS). The OS can comprise a Linux, Microsoft, or other similar standards-based interoperable OS, for example.

A process of an exemplary embodiment of the present invention will now be described with reference to the flowchart illustrated in FIG. 7 and various exemplary elements illustrated in FIGS. 1-6 and discussed above. In various embodiments, the process can comprises manually executed steps, steps involving human intervention, automatic steps, and/or computer/software implemented steps.

Accordingly, the present invention can include one or more multiple computer programs which may embody the functions described herein and illustrated in the exemplary figures. However, it should be apparent that there could be many different ways of implementing the invention in computer programming, and the invention should not be construed as limited to any one set of computer program instructions. Further, a skilled programmer would be able to write such a computer program to implement the disclosed invention without difficulty based on the exemplary data tables and flow charts and associated description in the application text, for example.

Therefore, disclosure of a particular set of program code instructions is not considered necessary for an adequate understanding of how to make and use the invention. The inventive functionality of any claimed computer programs or computer-implemented steps will be explained in more detail in the following description in conjunction with the remaining figures illustrating the functions and program flow.

Certain steps in the processes described below must naturally precede others for the present invention to function as described. However, the present invention is not limited to the order of the steps described if such order or sequence does not alter the functionality of the present invention. That is, it is recognized that some steps may be performed before or after other steps or in parallel with other steps without departing from the scope and spirit of the present invention.

Turning now to FIG. 7, this figure illustrates a flowchart of a process 700 for providing integrated access to a plurality of communication services in accordance with an exemplary embodiment of the present invention. The Process 700, which is entitled “Provide Integrated Access to Communication Services,” will be discussed with exemplary reference to various elements illustrated in FIGS. 1-6. Such reference is intended to be representative, rather than limiting.

At Step 705 of Process 700, a computing device resides on the wireless LAN 275. The device could be a handheld, an interactive remote control, a CRĀV device, a personal computer, a computer-based TV, a computer-based radio, a computer-based media system, a laptop, a router, a server, a home base station, an Internet-enabled appliance, etc.

In response to a user input or to some other event or stimulus, the computing device outputs a message onto the wireless LAN 275. The message is intended for receipt at a location offsite of the premises 125, typically at a remote site. As discussed above, the message is typically formatted in accordance with the protocol specifications of the wireless LAN 275.

The message can be addressed or otherwise marked for delivery at the remote site. The remote site could comprise an e-mail recipient either across town or on another continent, for example. The message could be an e-mail, a request to download information from a remote server, an instruction to establish a connection with a remote resource, an order to purchase a stock, or a vote that a user has cast (e.g. in association with CiviConnect), to name but a few possibilities.

At Step 710, the wireless LAN 275 conveys the message to the gateway 350, which receives the message. As discussed above, in an exemplary embodiment, the wireless LAN 275 typically operates within or in a vicinity of the premises 125. Accordingly, the wireless LAN 275 should link to a wider network to reach the intended recipient.

At Step 715, the gateway 225 receives the message and prepares the message for transmission over the WAN, specifically over the wireless mesh network 100 and any connecting networks, such as a fiber network 155, the PSTN 160, the Internet backbone 165, etc.

More specifically, the gateway 350 reformats the message from the format of the wireless LAN 275 to the format of the wireless mesh network 100. This reformatting can comprise mapping headers and other information using a lookup table or another reformatting tool, as will be available to one of skill in the art having the benefit of the disclosure present herein. Reformatting can further comprise encoding the content of the message onto a different wireless frequency.

The gateway 350 transmits the reformatted message onto the wireless mesh network 100. As discussed above, the transmitted message hops from the respective gateway 350 or other communication gear of the various premises 125 of the wireless mesh network 100 as the message travels to the recipient.

At Step 720, the gateway 350 receives a stream or a series of IP packets 525, 550 from the wireless mesh network 100. The stream contains IP packets 525 that contain data specifically intended for receipt by the computing device on the wireless LAN 275. Other IP packets 550 contain media content, such as IPTV content, HDTV content, digital TV content, digital radio content, etc.

The stream of packets is not necessarily continuous or steadily ongoing. Rather, the steam can comprise an intermittent feed or a burst of various IP packets, sometimes including data packets, sometimes including media packets, sometimes including both or neither.

Each packet 525, 550 typically comprises a formatted block of information or data carried by the wireless mesh network 100. Each packet 525, 550 typically has a header that marks the beginning of the packet 525, 550; a payload that comprises data, images, or media content; and a trailer that marks the end of the packet 525, 550.

With a series of packets, 525, 550 transmitting over the network 100, the header of one packet 525, 550 will follow the trailer of the preceding packet 525, 550. However, the wireless mesh network 100 may be idle between time periods of active communication.

As an alternative to using packet communication, an exemplary embodiment of the wireless mesh network 100, the gateway 350, and the wireless LAN 275 can operate via transmitting a series of bytes, characters, or bits.

At Step 725, the packet segregation module 450 of the gateway 350 segregates or separates the media packets 550 from the data packets 550. The segregation proceeds as discussed above with reference to FIGS. 4 and 5.

At Step 735, the gateway 350 reformats the incoming data packets 500 to conform to the communication specifications of the wireless LAN 275. As discussed above, reformatting the data packets 550 can comprise encoding a wireless carrier signal, having the frequency of the wireless LAN 275, to carry the data present in the received data packets 500.

The gateway 350 emits the reformatted data signal over the wireless LAN 275 for receipt by the computing device that is the intended recipient and that is present on the wireless LAN 275.

At Step 745, the gateway 350 processes the media packets 550 to create an analog signal suited for receipt by the legacy TV 225. As discussed above, processing the media packets 550 typically comprises opening each media packet 550 to access the media content present therein in digital form. The HDTV-to-SDTV conversion module 455 typically converts the digital information of the media packets 550 into analog form using a digital-to-analog converter (DAC). The link 205 transmits the generated analog to the legacy TV 225 for presentation to the user.

At Step 750, the gateway 350 further processes the media packets 550 and generates an HDTV signal from the media packets 550. The HDTV signal is compatible with a digital TV at the premises 125. Thus, the gateway 350 feeds appropriate signals both to the legacy TV 225 and to the HDTV/digital TV.

At Step 755, the content tracking module 475 tracks media exposures or viewing statistics for the HDTV and the legacy TV 225. As discussed above, an exemplary embodiment of the content tracking module 475 can also track exposure statistics for essentially every media, computing, and/or communication appliance at the premises 125 that interfaces with the gateway 350. The content tracking module 475 typically accumulates a profile of the exposure statistics in memory over a defined period of time. The gateway 350 can transmit the profile to a central profiling center via a WAN, such as the network 100 or the network 150.

Following Step 755, Process 700 ends. As described, Process 700 executes exemplary steps for linking a plurality of communication, computing, and/or media devices of a premises 125 to a wireless mesh network 100 that comprises or connects to a WAN. Those devices and the network may have distinct format requirements. Accordingly, Process 700 provides a method for operating the gateway 350 as an integrated access point that bridges signal and format incompatibilities. Furthermore, the gateway 350 can generate profiles of media exposure (and/or computer usage) for each of multiple users at a premises 125.

From the foregoing, it will be appreciated that an embodiment of the present invention overcomes the limitations of the prior art. Those skilled in the art will appreciate that the present invention is not limited to any specifically discussed application and that the embodiments described herein are illustrative and not restrictive. From the description of the exemplary embodiments, equivalents of the elements shown therein will suggest themselves to those skilled in the art, and ways of constructing other embodiments of the present invention will suggest themselves to practitioners of the art. Therefore, the scope of the present invention is to be limited only by the claims that follow.

What is claimed is:

1. A method for providing a premises with integrated communication service, comprising the steps of:
receiving a first digital communication signal, carrying media content, from a network that communicates via Internet protocol and that extends beyond the premises;
modulating an analog signal according to the media content in response to processing the received first digital communication signal;
outputting the modulated analog signal for reception by a television at the premises;
receiving a second digital communication signal from a local network that communicates via another communication protocol;
generating a third digital communication signal, conforming to the Internet protocol, in response to processing the received second digital communication signal; and
transmitting the generated third digital communication signal over the network.

2. The method according to claim 1, further comprising the steps of:
receiving usage data from a plurality of media appliances located at the premises;
processing the received usage data to generate a profile of media consumption at the premises; and
transmitting the generated profile over the network.

3. The method according to claim 2, wherein the received usage data describes consumption of analog television, digital television, Internet media, and digital radio.

4. The method according to claim 2, wherein the profile of media consumption comprises a comprehensive profile of essentially all digital content consumed at the premises.

5. The method according to claim 2, wherein the received usage data represents essentially all the media content consumed at the premises that has arrived at the premises via signal transmission.

6. The method according to claim 1, wherein the local network comprises a wireless local area network essentially limited to the premises.

7. The method according to claim 6, wherein the network that extends beyond the premises comprises a mesh network connected to a residence at the premises and a plurality of other residences.

8. The method according to claim 7,
wherein receiving the first digital communication signal comprises receiving the first digital communication signal at an electronic enclosure located at the premises adjacent the television;
wherein modulating the analog signal comprises modulating the analog signal via a circuit disposed in the electronic enclosure;
wherein outputting the modulated analog signal comprises outputting the modulated analog signal from the electronic enclosure;
wherein receiving the second digital communication signal comprises receiving the second digital communication signal at the electronic enclosure;
wherein processing the second digital communication signal comprises processing the second digital communication signal with the circuit; and
wherein transmitting the generated third digital communication signal comprises outputting the generated third digital communication signal from the electronic enclosure.

9. The method according to claim 8, further comprising the steps of:
collecting, at the electronic enclosure, information describing media consumption at the premises; and
transmitting the collected information over the network.

10. The method according to claim 9, further comprising the step of producing an integrated profile of media consumption at the premises based on the collected information.

11. The method according to claim 8, further comprising the steps of:
producing, at the electronic enclosure, a record of essentially all consumption of digital media at the premises occurring during a time interval; and
transmitting the record from the electronic enclosure to a remote location on the network.

12. The method according to claim 8, further comprising the step of maintaining, at the electronic enclosure, a profile describing digital television viewership and analog television viewership for each of a plurality of users at the premises.

13. The method according to claim 8, further comprising the steps of:
receiving a fourth digital communication signal, conforming to the Internet protocol and carrying information from a remote Internet site, from the mesh network;
generating a fifth digital communication signal, conforming to the another communication protocol, in response to processing the fourth communication signal with the circuit; and
outputting the fifth digital communication signal onto the wireless local area network for receipt by a portable computing device at the residence.

14. The method according to claim 13, wherein the another communication protocol comprises Ethernet.

15. The method according to claim 1, wherein the first digital communication signal comprises one or more packets for carrying the media content, and wherein the media content comprises video content.

16. The method according to claim 1, wherein the network comprises a packet-switched network.

17. The method according to claim 1, wherein the network comprises a television distribution network.

18. A system for providing access to communication services, comprising:
a housing;
a receiver, disposed in the housing, operative to receive a first signal that carries video images with a first level of image resolution;
a first circuit, disposed in the housing and electrically coupled to the receiver, operative to produce a second signal that carries the video images with a second level of image resolution, substantially below the first level of image resolution, in response to processing the received first signal;
an output port, disposed at the housing and electrically coupled to the first circuit, operative to transmit the second signal for reception by a television that operates at the second level of image resolution;
a first antenna, attached to the housing, for interfacing to a local area network;
a second antenna, attached to the housing, for interfacing to a wide area network; and
a second circuit, disposed in the housing and electrically coupled to the first antenna and to the second antenna, operative to reformat signals passing between the local area network and the wide area network via the first antenna and the second antenna.

19. The system according to claim 18, further comprising a storage device, disposed in the housing, for maintaining a first list of content received by the television and a second list of content received by a second television that operates at the first level of image resolution.

20. The system according to claim 18, further comprising a module, at least partially disposed within the housing, that is operative to track first content displayed on the television and second content displayed on another television that operates at the first level of image resolution.

21. The system according to claim 18, further comprising a memory system, disposed in the housing, containing an integrated profile of media consumption for each user at a residence associated with system.

22. The system according to claim 18, further comprising a module, comprising software and memory, for tracking essentially all media content that the system processes during a time frame.

23. The system according to claim 18, further comprising a memory register that tracks usage of essentially all media appliances at a residence at which the system is located.

24. The system according to claim 18, further comprising a capability to track observations of television content, radio content, and Internet content based on signals passing through the system.

25. The system according to claim 18, wherein at least one of the first antenna and the second antenna is mounted external to the housing and is coupled to the housing via a conductor.

26. The system according to claim 18, wherein the first signal comprises an airborne digital television signal, and wherein the receiver comprises a third antenna for receiving the airborne digital television signal.

27. The system according to claim 18, wherein the first signal comprises a wireless signal that conforms to Internet protocol.

28. The system according to claim 18, wherein the wide area network comprises the Internet.

29. The system according to claim 18, wherein the wide area network comprises a mesh network that is operative to transmit the first signal to the receiver.

30. The system according to claim 18, wherein the wide area network comprises a distributed computing network that conveys to the receiver video packets containing the video images and data packets destined for the local area network.

31. The system according to claim 18, wherein the system further comprises an interactive remote control, within the housing, for controlling the television, and wherein the housing is sized to fit in a hand of a user.

32. A communication gateway, for providing a television and a wireless local area network with communication connectivity, comprising:
a receiver, operative to receive first television signals providing a first level of image definition and propagating in air;
a transceiver, operative to provide bidirectional data communication with the wireless local area network; and
a signal processing system operably connected to an output of the receiver and to the transceiver, the signal processing system operative to perform the steps of:
converting the received first television signals into second television signals, providing a second level of image definition substantially below the first level of image definition, for reception by the television;
formatting first data signals, that the transceiver receives from the wireless local area network, for transmission over a wide area network via Internet protocol; and
formatting second data signals from the wide area network for transmission over the wireless local area network via the transceiver.

33. The communication gateway according to claim 32, wherein the signal processing system is further operative to provide the first television signals for reception by a second television that is compatible with the first level of image definition.

34. The communication gateway according to claim 32, wherein the signal processing system is further operative to track content displayed on each of the first television and the second television.

35. The communication gateway according to claim 34, wherein the signal processing system is further operative to track showings of Internet-based content according to the first data signals or the second data signals.

36. The communication gateway according to claim 32, further comprising a monitor that tracks media consumption for essentially all media appliances, at a residence, that communicate through the communication gateway.

37. The communication gateway according to claim 32, further comprising an integral tracking device that compiles usage statistics for each device at a premises that receives content through the communication gateway.

38. The communication gateway according to claim 32, further comprising an integral tracking device that compiles usage statistics for each device at a premises that transmits data through the communication gateway.

39. The communication gateway according to claim 32, further comprising a memory register that stores usage statistics for a plurality of appliances, at a premises, that communicate with the communication gateway.

40. The communication gateway according to claim 32, wherein the wide area network comprises a wireless mesh network,
wherein the first television signals comprise signals transmitted over the wireless mesh network via Internet protocol,
wherein the transceiver comprises a transmitter and a second receiver, and
wherein the communication gateway further comprises a portable housing that encloses the receiver, the transceiver, and the signal processing system.

41. The communication gateway according to claim 32, wherein the receiver is further operative to receive the second data signals from the wide area network.

42. The communication gateway according to claim 32, wherein the receiver is operative to receive a packet signal that comprises first and second packets, the first packets comprising the first television signals, and the second packets comprising the second data signals, and
wherein the signal processing system is further operative to perform the steps of:
segregating the first packets and the second packets in response to processing the received packet signal;
extracting the first television signals from the first packets, for conversion into the second television signals; and
extracting the data signals from the second packets, for formatting for transmission over the wireless local area network.

43. The communication gateway according to claim 32, further comprising a handheld housing that encloses the receiver, the transceiver, and the signal processing system, wherein the signal processing system is further operative to change a channel of the television in response to an input from a user.

44. A communication method, comprising the steps of:
receiving packets from a wireless mesh network;
processing the received packets to identify packets carrying video content and packets carrying data;
separating the packets carrying video content from the packets carrying data;
formatting the data for transmission over a wireless local area network in response to processing the packets carrying data;
transmitting the formatted data over the wireless local area network for receipt by a computing device;
generating an analog signal carrying the video content in response to processing the packets carrying video content; and
transmitting the generated analog signal for reception by an analog television.

45. The communication method according to claim 44, further comprising the step of processing the packets carrying video content to provide a digital signal for reception by a digital television.

46. The communication method according to claim 45, further comprising the step of monitoring content displayed on each of the digital television and the analog television.

47. The communication method according to claim 45, further comprising the step of tracking viewership of the video content shown on each of the digital television and the analog television.

48. The communication method according to claim 47, further comprising the step of tracking usage of the computing device according to transmissions over the wireless local area network.

49. The communication method according to claim 44, wherein the wireless mesh network comprises a first virtual network that handles the packets carrying video content and a second virtual network that handles the packets carrying data.

50. The communication method according to claim 49, wherein the first virtual network comprises a television distribution network.

51. The communication method according to claim 50, wherein the video content carried by the analog signal has lower image resolution than the video content of the packets carrying video content.

52. A method for providing a residence with television service via an onsite gateway, comprising the steps of:
receiving first television signals, carrying video images at a first level of image resolution, at the gateway;
providing, from the gateway, a first television system with the received first television signals, the first television system disposed at the residence and operating at the first level of image resolution;
processing, at the gateway, the received first television signals to provide a second television system with second television signals carrying the video images at a second level of image resolution, the second television system disposed at the residence and operating at the second level of image resolution; and
tracking, at the gateway, usage statistics for each of the first television system and the second television system.

53. The method according to claim 52, wherein the first level of image resolution is higher than the second level of image resolution.

54. The method according to claim 52, further comprising the step of tracking Internet usage at the residence based on data signals flowing through the gateway.

55. The method according to claim 54, further comprising the step of tracking digital radio usage at the residence based on radio signals processed by the gateway.

56. The method according to claim 52, further comprising the step of recording content flowing through the gateway in response to a prompt from a user at the residence.
